(19) United States
(12) Patent Application Publication
(10) Pub. No.: US 2013/0212189 A1
(43) Pub. Date: Aug. 15, 2013

(54) SYSTEMS AND METHODS FOR SHARING ONLINE CONTENT

(71) Applicant: Ioannis VELISSARAKOS, Great Falls, VA (US)

(72) Inventor: Ioannis VELISSARAKOS, Great Falls, VA (US)

(21) Appl. No.: 13/396,166

(22) Filed: Feb. 14, 2012

(51) Int. Cl. G06F 15/16

(52) U.S. Cl. 709/206

(57) ABSTRACT

Systems and methods are disclosed for sharing online content and, in particular, for allowing users of an online community to manage the delivery and sharing of messages received from other users of the community or those external to the community. In one or more implementations, the system may include clients, servers, and a network. Clients may communicate with the servers using the network in order to exchange data, messages, and other content with users of the online community. The online community includes configurable settings, allowing users to control the manner in which messages are delivered to them, as well as the extent to which their sent messages are automatically shared with users not identified by the sender. Using the online community, users may also communicate with, and receive communications from, individuals that have accounts on social media websites.

### TECHNICAL FIELD

This disclosure relates generally to systems and methods for sharing online content, and more particularly, to managing the delivery and sharing of messages and content in an online community.

### BACKGROUND

It is a common occurrence for internet users to send messages and share content with one another. For example, organizations may electronically distribute newsletters to a list of subscribers on a regular basis. Retailers may send periodic advertisements to the inboxes of many users. Family, friends and acquaintances may send messages, invitations, announcements, and so forth, to one another. In a similar fashion, users of online communities (such as social media websites and forums) send many messages to one another.

In many cases, internet users share messages directly with others. For instance, the recipient of an e-mail message may forward that message to an individual whom the recipient believes may be interested in the contents of the message. Alternatively, a user may manually create or select a list of people who should receive the message. Such a list may include individuals that share something in common, e.g., a common interest, familial connection, or membership in an organization.

In addition to exchanging messages with one another, internet users increasingly communicate within the realm of online communities, including forums, blogs, and social media websites. These online environments may be more visible to the general population of internet users and may feature a more open communication platform. Moreover, online communities, such as social media websites, are becoming increasingly accessible.

For instance, a user may be able to join a social media website by completing a registration page and submitting a valid email address and a private password. The user may be given a profile page to configure, which may include information pertaining to the user's background, interests, experience, and contacts. The user may further be able to establish connections with other users (e.g., by sending a connection request). A user's contact information, which may be stored on network servers, may be displayed privately or publicly to visitors of the user's profile page.

Despite the prevalence of sending and receiving messages, as well as the increasing popularity of online communities, internet users are often unable to fully control the manner in which they receive messages. For instance, a subscriber to an online newsletter is typically unable to control the time and frequency of delivery of the newsletter to his or her inbox. In addition, the format and medium of delivery are generally outside of the recipient's control. In the example above, a subscriber may have the option of unsubscribing from a mailing list, but the consequence is that the subscriber no longer receives any newsletters going forward, which may not be what the subscriber actually wants.

On the other hand, a sender of a message is typically not in the best position to determine which users would want to receive a particular message. To illustrate, an individual may want to share a message related to photography with a group of users. To avoid the risk of excluding anyone, the individual may decide to send his or her message to the entire group of users. One possible result is that some of the recipients did not have any interest in the message. These users may then decide to unsubscribe because they receive too many messages outside of their interests. Alternatively, some recipients may have preferred to receive the message at a later time and in a different format or medium.

It would therefore be desirable to provide an online community that enables users to control how messages are shared. Senders may appreciate the ability to better select a group of recipients and to control how their sent messages are being shared with others. Recipients may appreciate the ability to control the manner in which they receive messages, including the time, frequency, format and medium of delivery.

### SUMMARY

Systems and methods for sharing online content consistent with disclosed embodiments are described. In one embodiment, a message sent to a user of an online community may be delivered based on the user's settings. The user may configure the settings to allow for direct delivery of messages, or to allow notification alerts for received messages to be sent to the user at a certain time or frequency. In another embodiment, a message sent by a user of an online community may be automatically posted on one or more of the user's social media accounts. For example, the user may configure their settings so that anytime a message is sent, the message is posted to his or her online community account, as well as to any other social media communities of which the user may be a member. In addition, a message generated in response to a message posted on a social media community may in turn be posted on the online community account of users associated with the generated message.

In another embodiment, a message delivered to a user may be automatically shared with other users, based on how the settings of the sender and downstream recipients are configured. For example, a user may allow their sent messages to be automatically shared with downstream users they did not identify as recipients, and downstream recipients may choose to automatically receive messages from the user. In another embodiment, a message delivered to a user may be automatically posted to that user's magazine, based on how the settings of the sender and the user are configured. A magazine may be a part of a user's online community account that is used for posting and publicly sharing content. To illustrate, the sender may allow their sent messages to be automatically posted, and the user may configure their settings to allow for automatically posting messages received from the sender.

It is to be understood that both the foregoing general description and the following detailed description are exemplary and explanatory only and are not restrictive of the application, as claimed.

The accompanying drawings, which are incorporated in and constitute a part of this specification, illustrate embodiments of the application and together with the description, serve to explain the principles of the application.

### BRIEF DESCRIPTION OF THE DRAWINGS

FIG. 1 is an exemplary illustration of system of an online community that may be used to implement disclosed embodiments, including exemplary system components;

FIG. 2 is an exemplary illustration of a process for message dissemination from the perspective of a message recipient, consistent with disclosed embodiments;

FIG. 3 is an exemplary illustration of processes for social auto-posting of a message and message dissemination from the perspective of a message sender, consistent with disclosed embodiments;

FIG. 4 is an exemplary illustration of a process for posting a message associated with one or more users' social media accounts to one or more of the users' respective online community accounts, consistent with disclosed embodiments;

FIG. 5 is an exemplary illustration of a process for generating a notification alert based on user settings, consistent with disclosed embodiments;

FIG. 6 is an exemplary illustration of a process for automatically sharing a message with other users, which may include one or more lists or groups of users, consistent with disclosed embodiments;

FIG. 7 is an exemplary illustration of a process for automatically posting a message on an individual or group magazine, consistent with disclosed embodiments; and

FIG. 8 is an exemplary illustration of a process for sharing offline content using a mobile application, consistent with disclosed embodiments.

### DETAILED DESCRIPTION

Reference will now be made in detail to exemplary embodiments, examples of which are illustrated in the accompanying drawings. Wherever possible, the same reference numbers will be used throughout the drawings to refer to the same or like parts.

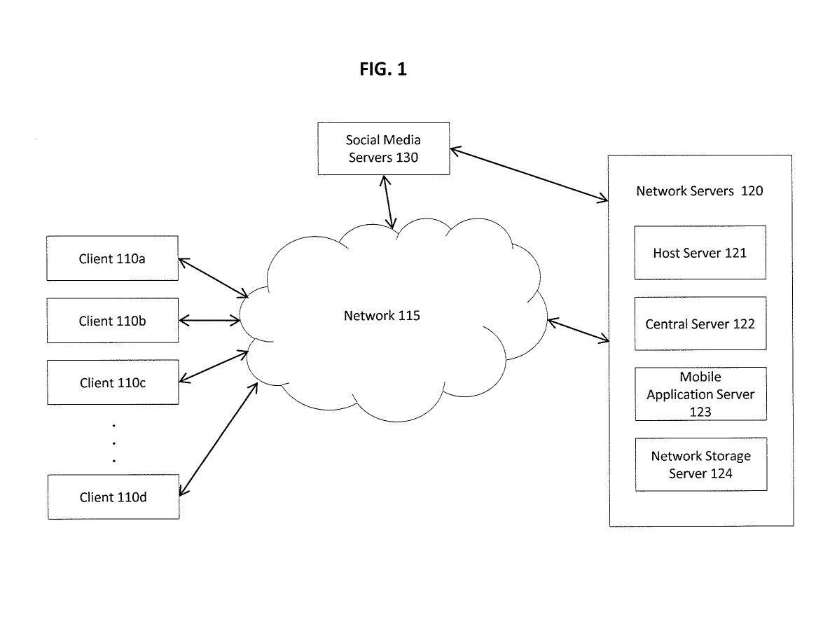

FIG. 1 is a diagram illustrating an exemplary system of an online community that may be used to implement disclosed embodiments, including exemplary system components. The components and arrangement, however, may vary. For example, clients 110a-110d (collectively referred to as clients 110), network 115, and one or more network servers 120 may be implemented in various ways. Clients 110 may each include one or more of general purpose computers, mobile phones, or any handheld devices capable of communicating over a network. Network 115 may include a local area network (“LAN”) or other network that is a portion of a larger network or system of networks (e.g., an enterprise network). Network 115 may also include the Internet. Network servers 120 may include one or more host servers 121, central servers 122, mobile application servers 123, or network storage servers 124, as well as other servers or server systems not depicted in FIG. 1. Social media servers 130 may represent a plurality of servers used to operate and/or host social media websites, such as Facebook™ or Twitter™.

Clients 110, network servers 120, and social media servers 130 may include combinations of hardware and/or software configured consistent with the teachings presented herein. For example, clients 110, network servers 120, and social media servers 130 may include one and/or more processors or microprocessors. Likewise, they may include one or more volatile or non-volatile, magnetic, semiconductor, tape, optical, removable, nonremovable, or other type of storage device or computer-readable medium. The computer-readable medium may store instructions that, when executed, cause the one or more processors and/or microprocessors to perform functions consistent with disclosed embodiments. Further, clients 110, network servers 120, and/or social media servers 130 may also be configured with an operating system (not shown) that performs functions known in the art when used during operation of the online community. By way of example, the operating system may be Microsoft Windows™, Unix™, Linux™, Solaris™, or some other operating system. The choice of operating system, and even to the use of an operating system, is not critical to any embodiment.

Network servers 120 may perform different functions in the context of the system of an online community, although certain functions may be performed by more than one server. For example, a plurality of host servers 121 may serve as the interface between clients 110 and the online community as a whole. One or more central servers 122 may be responsible for interconnecting host servers 121, as well as establishing or receiving certain communications between the online community and clients 110. A plurality of mobile application servers 123 may interface clients 110 using a mobile application with the online community. In addition, network storage server 124 may be used to access and/or store user data, including messages, multimedia, user settings and preferences, as well as other content associated with the online community.

Various intercommunications may occur among the system components illustrated in the diagram of FIG. 1. Clients 110 may communicate with the network servers 120 over network 115. For instance, client 110a using a general purpose computer may initiate an operation permitted by the online community by communicating with host server 121. Similarly client 110a using a mobile device may transmit commands to, and/or receive data from, mobile application server 123. Various intercommunications may also occur among network servers 120. For example, central server 122 may communicate with host server 121 and network storage 124 in response to commands issued by client 110a. The network servers 120 may communicate directly with the social media servers 130 during operation of the online community. Peer-to-peer communications between clients 110 may also be contemplated within various embodiments. Further, the communication channels may include both wired and wireless communication links, with the appropriate communication protocols. Particular routing protocols may also be used to ensure delivery of messages and other data among the components of the online community. The choice of communication channels and routing protocols are not critical to any embodiment.

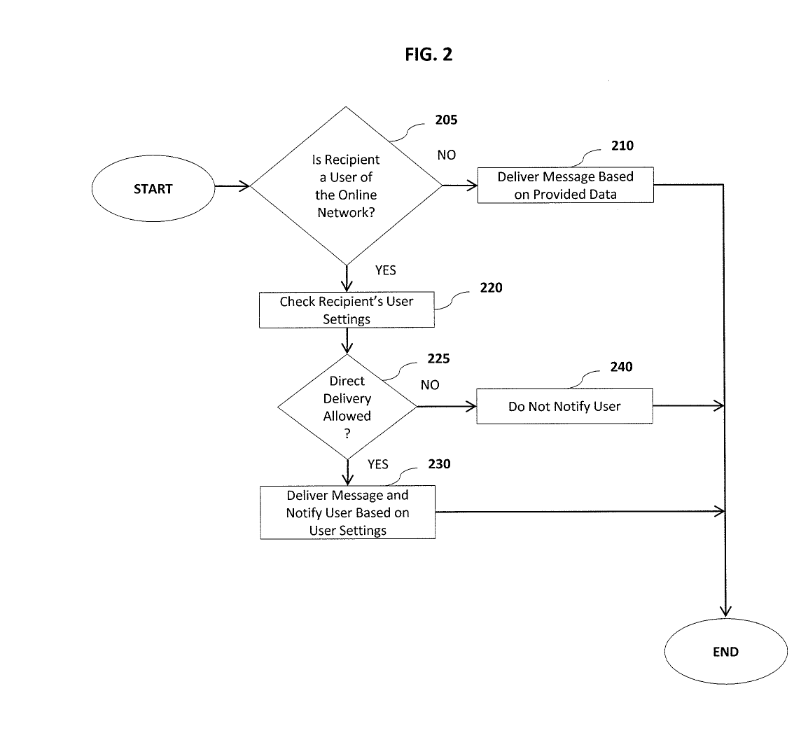

FIG. 2 is a flow diagram illustrating an exemplary process for message dissemination and delivery notification from the perspective of a message recipient. The process of FIG. 2 may be performed by one or more of the components of the system described with respect to FIG. 1, for example. A recipient is not limited to an individual user and may include a list of users, such as users appearing in a distribution list. A recipient may also include “groups;” in one or more embodiments, a group may comprise a set of users added to the group based on at least the operation of a grouping procedure. For example, a group of users may be formed based on a common interest held by the users. At Step 205, the system may determine whether the recipient is a member of the online community. If the system determines that the recipient is not a member of the online community, the message may be delivered to the recipient at Step 210 based on any recipient data provided with the message. Such data may be specified by the sender of the message, and may include an e-mail address, mobile phone number, and/or social media account information for websites such as Facebook™ or Twitter™. Consistent with disclosed embodiments, the message may be delivered to a social media account by using the sender's account on the same social media website. For example, if the sender is a user of the online community and has an account on social media website X, and the intended recipient has an account on social media website X, the sender's message may be delivered by the online community using the sender's account on the social media website.

On the other hand, if the system at Step 205 determines that the recipient is a member of the online community, the system may check the recipient's user settings at Step 220. User settings may include options for direct delivery of messages, e.g., delivery upon receipt of a message and notification that a message has been delivered. User settings may also include options for the delivery medium. For example, a user may choose to have messages delivered to an e-mail address, a mobile phone, a social media account on a website such as Facebook™ or Twitter™, or any combination thereof. Further still, user settings may include options for “notification rules.” These rules may relate to when and/or how often a user is notified that a message has been delivered to his or her online community account. For example, a user may choose to receive notifications of delivered messages at one or more specified times on one or more specified days (e.g., 12:00 pm on Mondays, or the first day of every month). User settings may also be configured differently for different types of messages. For instance, a user may choose to receive daily notifications of messages from family and friends while electing to receive notifications of messages from retailers every Friday only.

At Step 225 of FIG. 2, the system determines whether direct delivery of a message is allowed. The system may identify one or more delivery mechanisms associated with the recipient. In addition, the system may determine whether direct delivery is allowed based on at least the recipient's user settings. If a new type of message is being delivered for the first time from a particular sender, the system may prompt the user to either accept or reject the message, and/or to establish settings controlling delivery of similar messages in the future. The system may also prompt the user to configure notification rules relating to when and/or how often the user should be notified that such a message has been delivered to his or her online community account. For example, the first time a message is delivered from a particular sender, a user may be asked to select whether messages from the same sender should be delivered and stored in the user's account and, if so, the user may be asked to specify when and/or how often the user would like to receive delivery notifications for similar messages. The user may also be able to specify, based on the type of message and its content, which messages to accept from the sender. For instance, the user may be able to configure settings so that only non-commercial newsletters from a particular sender will be delivered to the user's online community account. Finally, if the system determines that direct delivery is allowed, then the message is delivered—based on the identified delivery mechanisms associated with the recipient and the recipient's user settings—and the user is notified of its delivery at Step 230. Otherwise, as illustrated at Step 240, the system does not notify the user that a message has been received, and the process terminates.

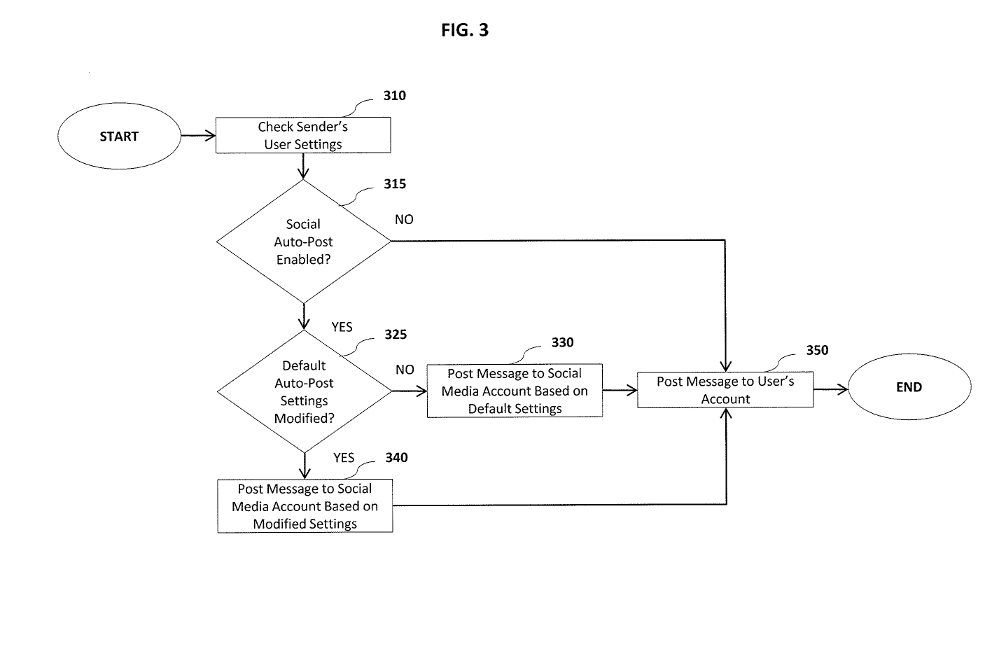

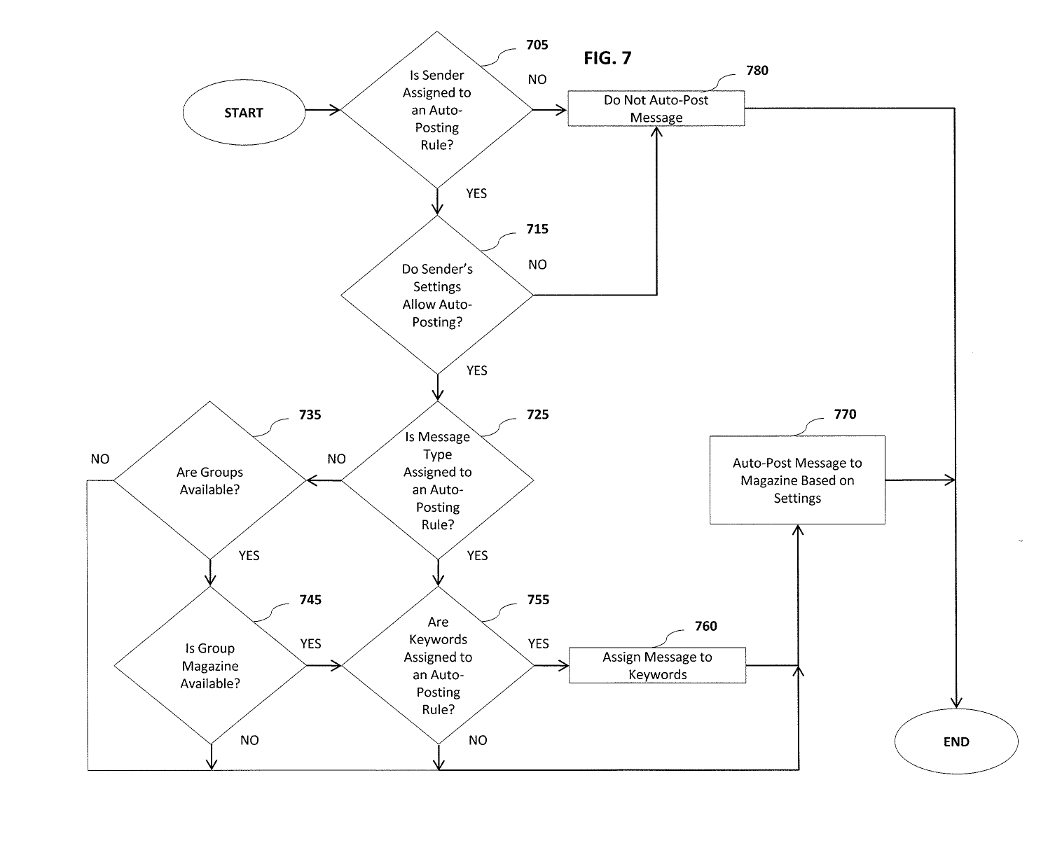

FIG. 3 is a flow diagram illustrating exemplary processes for social auto-posting of a message and message dissemination from the perspective of a message sender. The process of FIG. 3 may be performed by one or more of the components of the system described with respect to FIG. 1, for example. Consistent with disclosed embodiments, a sender may allow messages to be automatically posted to a social media website. Social auto-posting may involve, for example, sharing a message on the sender's social media accounts (such as Facebook™ or Twitter™), in addition to posting the message publicly or privately on the sender's online community account. First, the system may check the sender's user settings at Step 310. After checking the sender's user settings, the system may determine at Step 315 whether social auto-posting is enabled, based on at least the configuration of the sender's user settings. If the system determines that social auto-posting is not enabled, the message may be posted to the sender's online community account at Step 350. The sender's online community account may include an area that is generally viewable by other internet users (e.g., a web page—containing user-generated content or content made available from an external web page—that is associated with the user's online community account). This “public” area may be referred to as the user's “magazine,” which will be further described in connection with FIG. 7. The sender's online community account may also include an area that is private, and accessible only to the user (e.g., a web page associated with the user's online community account displaying all messages sent or received by the user).

On the other hand, if the user settings are configured to enable social auto-posting, the system may determine whether the default auto-posting settings have been modified at Step 325. For example, for a particular message, the sender may have changed the default auto-posting settings. If the default auto-posting settings have not been modified, the message may be publicly posted at Step 330 to one or more of the sender's social media accounts (such as Facebook™ or Twitter™), based on at least the default settings. Similarly, if the default auto-post settings have been modified, the message may be posted to the sender's social media accounts based on the modified settings at Step 340. The modified settings may apply only to that particular message or they may also apply to future messages. After the message has been shared on one or more of the sender's social media accounts, the message may be posted to the sender's online community account at Step 350. As outlined above, the sender's online community account may include both a public magazine and a private area accessible only by the sender.

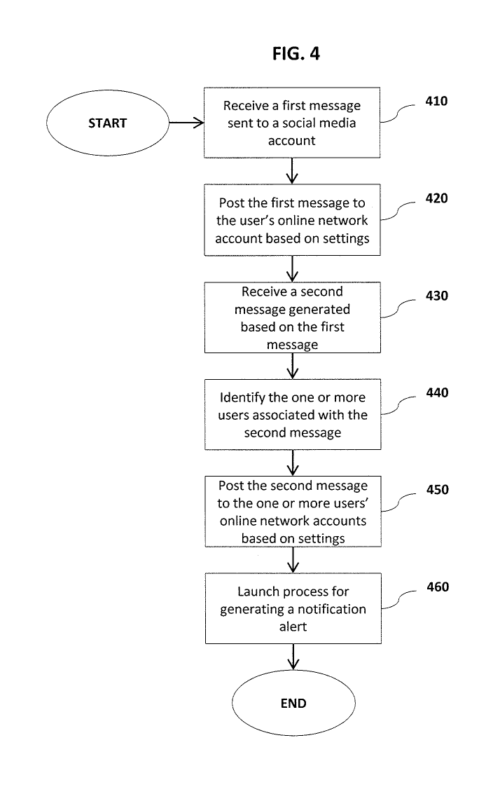

FIG. 4 is a flow diagram illustrating an exemplary process for posting a message associated with one or more users' social media accounts to one or more of the users' respective online community accounts. The process of FIG. 4 may be performed by one or more of the components of the system described with respect to FIG. 1, for example. At Step 410, an online community user may send a message to a recipient's social media account (such as Facebook™ or Twitter™. For instance, the online community may interface with the sender's social media account to send the message using the social media network as a medium. The message may include (but is not limited to) a posting, a comment, a private message or a multimedia message. At

Step 420, the message may be posted to the sender's online community account—i.e., to the sender's magazine and/or private account area—based on at least the sender's user settings.

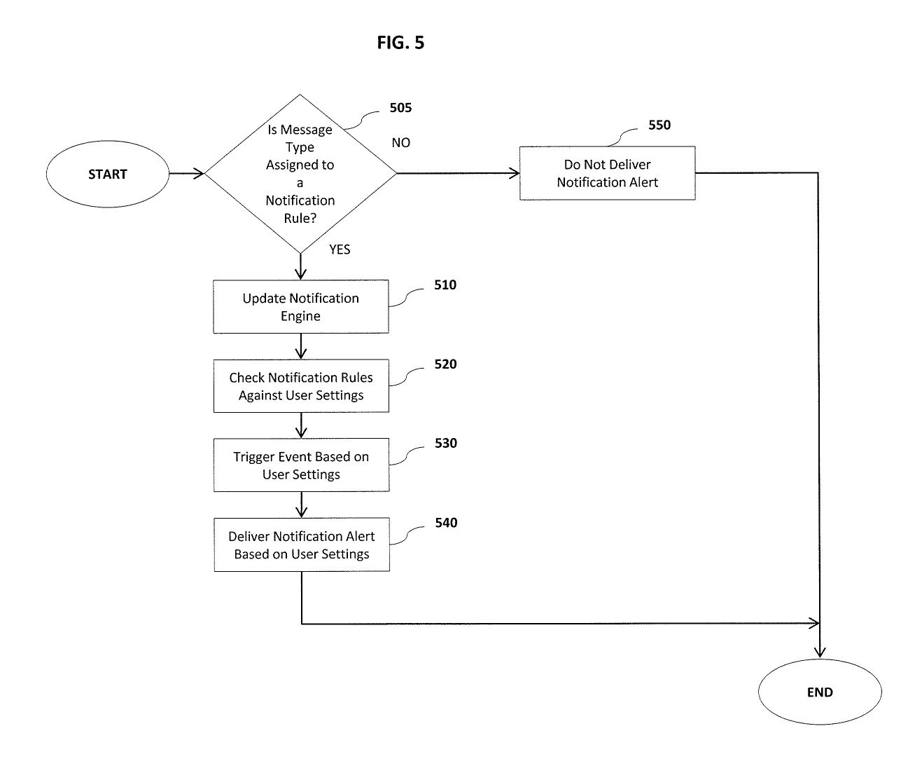

Next, a second message may be generated at Step 430, where the message is associated with one or more users of the online community. For example, the second message may be generated in response to the first message (e.g., the recipient of the first message posts a comment responding to the message). In another instance, the recipient of a private message may send a reply to the original sender as well as to other users of the social media network. At Step 440, the system identifies the sender and one or more recipients of the second message, and determines whether the sender and recipients are associated with online community accounts. The system may perform this identification by, for example, cross-referencing the social media account data with account information stored in the online community system. At Step 450, the system may post the second message to the online community accounts (including one or more magazines and/or private account areas) identified at Step 440, based on at least the user settings for each respective account. Finally, at Step 460, the system may initiate the process for generating a notification alert, as illustrated in FIG. 5 and described in further detail below.

FIG. 5 is a flow diagram illustrating an exemplary process for generating a notification alert based on user settings. The process of FIG. 5 may be performed by one or more of the components of the system described with respect to FIG. 1, for example. Consistent with disclosed embodiments, and as described above, a notification alert may be generated in response to the receipt of a message, based on at least the recipient's user settings. At Step 505, the system determines whether the message type is assigned to a notification rule. For example, a user may specify notification rules for one or more message types—which may include (but are not limited to) newsletters, advertisements, incoming messages, and private messages—received from one or more senders. For instance, a user may configure the notification rules to generate an alert each time an incoming message regarding a particular topic is received from a particular sender. If the system determines that the message type is not assigned to a notification rule, then no notification alert is generated (as illustrated at Step 550) and the process terminates. If, on the other hand, the system determines that the message type is assigned to a notification rule, at Step 510, the notification engine may be updated to account for receipt of a new message belonging to a certain message type. For instance, the system may update the notification engine by raising a flag, indicating that a notification alert should be sent to the user in accordance with the user's settings. At Step 520, the system may check—at predetermined time intervals—the notification rules for each given message type against the recipient's user settings. The user settings may control broader aspects of receiving messages, such as the notification and delivery options based on at least time and/or frequency. Once a match is found between the message type and the recipient's user settings, the system at Step 530 may trigger an event based on the member's settings. An event may be triggered, for example, based on the user's selected time zone. Steps 505 through 530, as outlined above, may be repeated indefinitely as long as a flag is raised or there is otherwise an indication that an outstanding notification must be sent to the user in accordance with the user's settings. Finally, at Step 540, the system may deliver a notification alert to one or more media such as an e-mail account or social media account, based on the recipient's user settings. In addition, the notification alert may correspond to a plurality of messages, where the messages may be related to one another in some way. By way of example, a single notification alert may be generated for all messages of a certain type (e.g., newsletters sent by a particular sender) received within a particular time frame (e.g., the past twenty-four hours). The notification alert may include, for each message, the subject or message title, sender and recipient information, a timestamp indicating when the message was received, and/or other pertinent information related to the message.

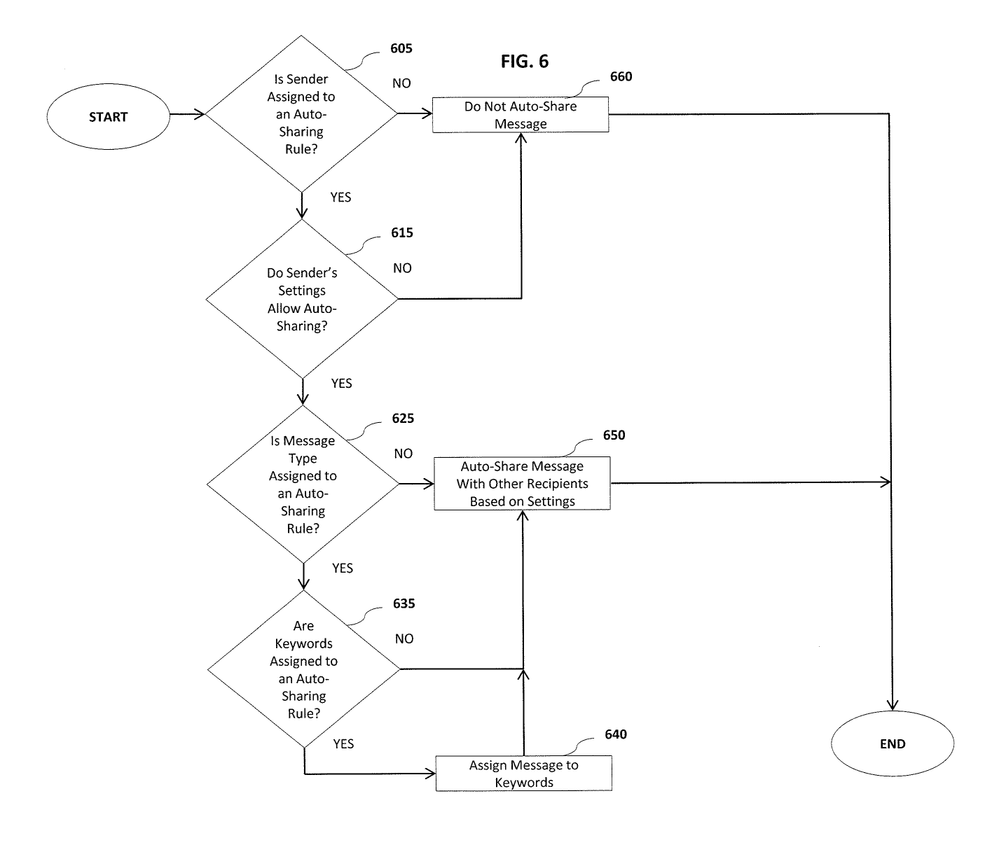

FIG. 6 is a flow diagram illustrating an exemplary process for automatically sharing a message with other users, which may include one or more lists or groups of users. The process of FIG. 6 may be performed by one or more of the components of the system described with respect to FIG. 1, for example. Consistent with disclosed embodiments, the auto-sharing process may occur during posting of a message to a recipient's online community account. The system may determine whether the sender of a message is assigned to an auto-sharing rule at Step 605. For example, the recipient's user settings may specify that a particular sender is assigned to a particular auto-sharing rule. Conversely, the user settings may be configured to disallow auto-sharing of any content sent by one or more senders. If the system determines that the sender is assigned to an auto-sharing rule, the system may then determine, at Step 615, whether the sender's user settings allow the sender's messages to be auto-shared. That is, the sender may also control whether the sender's messages are automatically shared with others. If the system determines that either the sender of a message is not assigned to an auto-sharing rule, or the sender's users settings do not allow the sender's messages to be auto-shared, then the message is not auto-shared (as illustrated at Step 660) and the process terminates.

If, at Step 615, the system determines that the sender's user settings allow auto-sharing, then the system may determine at Step 625 whether the recipient has assigned the message type to an auto-sharing rule. For example, a recipient's user settings may allow auto-sharing for certain types of messages (e.g., newsletters) but not others (e.g., private messages). If the system determines that the recipient has assigned the message type to an auto-sharing rule, the system may determine at Step 635 whether keywords are assigned to an auto-sharing rule. Consistent with disclosed embodiments, keywords may be used to summarize the content of a message. If the system determines that keywords are assigned to an auto-sharing rule, then the message may be assigned to one or more categories of keywords at Step 640. For instance, this assignment may occur based on an analysis of the format and/or content of the message. Keyword categories are non-limiting and may be defined broadly (e.g., geographical locations), or narrowly (e.g., local restaurants). Moreover, different users may define keyword categories differently, and thus, the assignment of keywords to a given message may not be identical across recipients.

At Step 650, based on determinations that the sender is assigned to an auto-sharing rule and the sender's user settings allow auto-sharing, the message may be shared with other users. The message may be shared with other users even if the message type is not assigned to an auto-sharing rule. Similarly, the message may be shared with other users even if keywords are not assigned to an auto-sharing rule. Consistent with disclosed embodiments, the message may be shared based on the user settings of other users. For instance, a user's (or group's) settings may specify certain “interests,” and these interests may then be compared with the keyword categories assigned to a message. Where there is a “match,” the message may be auto-shared with the individual or group. Once a message has been auto-shared, the entire process as illustrated in FIG. 6 may be reiterated.

FIG. 7 is a flow diagram illustrating an exemplary process for automatically posting a message on an individual or group “magazine.” The process of FIG. 7 may be performed by one or more of the components of the system described with respect to FIG. 1, for example. Consistent with disclosed embodiments, a magazine may be a part of a user's online community account that is used for posting and publicly sharing content. At Step 705, the system may determine whether the recipient has assigned the sender of a message to an auto-posting rule. For example, the recipient's user settings may specify that a particular sender is assigned to a particular auto-posting rule. Conversely, the user settings may be configured to disallow auto-posting of any content sent by one or more senders. If the system determines that the sender is assigned to an auto-posting rule, the system may then determine at Step 715 whether the sender's user settings allow the sender's messages to be auto-posted. That is, the sender may also control whether the sender's messages are automatically posted to the recipient's magazine. If the system determines that either the recipient has not assigned the sender of a message to an auto-posting rule, or the sender's user settings do not allow auto-posting of the sender's messages, then the message is not auto-posted (as illustrated at Step 780) and the process may terminate.

If, on the other hand, the system determines that the sender's user settings allow auto-posting, the system may determine at Step 725 whether the message is of a type that is assigned to an auto-posting rule. For example, a recipient's user settings may allow for certain types of messages (e.g., newsletters) but not others (e.g., private messages) to be automatically shared with others. If the message is not assigned to an auto-posting rule, the system may determine at Step 735 whether the recipient is a member of a group with its own auto-posting rules. If, at Step 735, the system determines that the recipient is a member of a group with its own auto-posting rules, the system then checks whether the group has enabled use of a magazine at Step 745.

If the system determines that the message is of a type that is assigned to an auto-posting rule, or that a group (of which the recipient is a member) has enabled use of a magazine, the system may determine at Step 755 whether keywords are assigned to an auto-posting rule. Consistent with disclosed embodiments, keywords may be used to summarily describe the content of a message. If the system determines that keywords are assigned to an auto-posting rule, then the message may be assigned to one or more categories of keywords at Step 760 based on, for instance, an analysis of the format and/or content of the message. Keyword categories are non-limiting and may be defined broadly (e.g., geographical locations) or narrowly (e.g., local restaurants). Moreover, different users may define keyword categories differently, and thus, the assignment of keywords to a given message may not be identical across recipients. Finally, at Step 770, based on determinations that the sender is assigned to an auto-posting rule and the sender's user settings allow auto-posting, the message may be posted to the magazine of one or more users and/or groups. The message may be posted to the magazine of one or more users and/or groups even if keywords are not assigned to an auto-posting rule. Similarly, the message may be posted to the magazine of one or more users and/or groups even if a group magazine is not available.

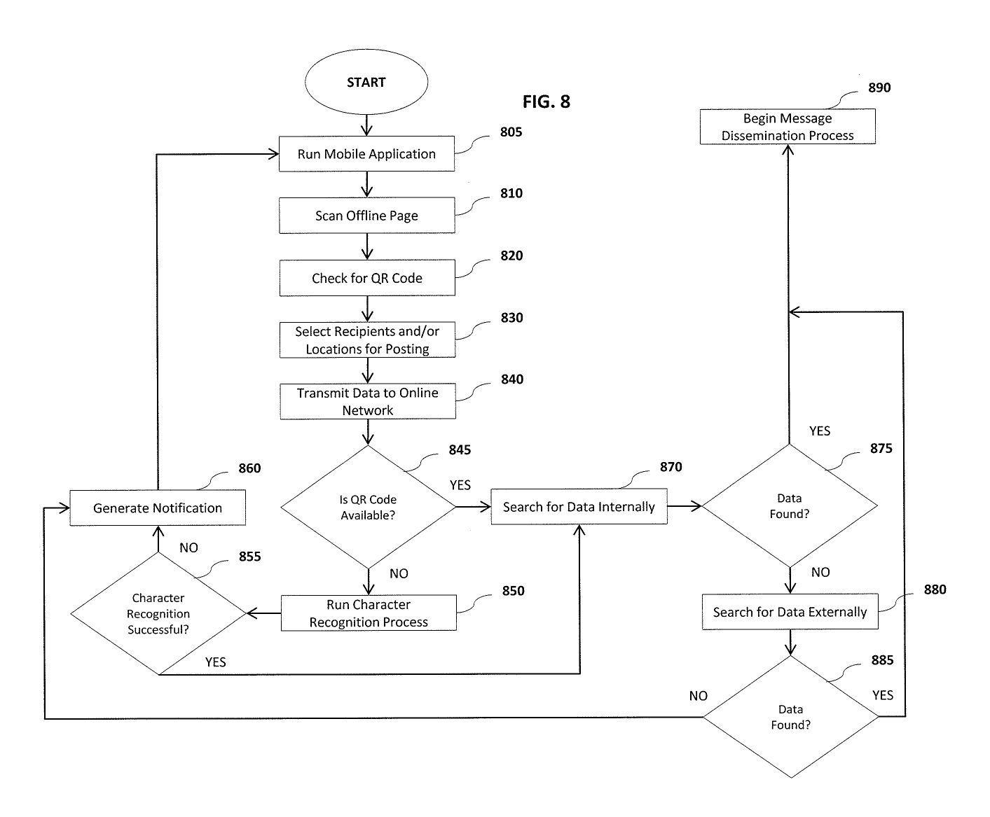

FIG. 8 is a flow diagram illustrating an exemplary process for sharing offline content using a mobile application. The process of FIG. 8 may be performed by one or more of the components of the system described with respect to FIG. 1, for example. At Step 805, a user may begin the process by running a mobile application, such as a mobile application capable of capturing images using a mobile device. The mobile application may be installed on and executed by an electronic device, such as a mobile phone or tablet computer. Consistent with disclosed embodiments, the user may scan a physical page (e.g., from a magazine or newspaper) or other form of offline content using the mobile application at Step 810. The scanned page may include a QR code. At Step 820, the system may check for the presence of a Quick Response (“QR”) code—or any other recognizable code—within the transmitted data. A QR code may be any type of barcode used to encode information, such as alphanumeric data. One type of barcode, for example, may consist of black modules arranged in a square pattern on a white background. Next, the user at Step 830 may select one or more recipients with whom to share the scanned content. The recipients may be members of one or more online communities and/or social media websites. In addition, the user at Step 830 may select a location, such as the user's online community account or one or more social media accounts, to post the content. For example, the user may choose to post the content to a plurality of such accounts. At Step 840, the content, along with the user's selections for sharing and posting the content, may be transmitted to the online community for dissemination. Prior to transmitting data, the mobile application may first sync with the online community.

At Step 845, the online community determines whether a QR code is available. If the online community was unable to identify a QR code, it may run a character recognition process on the transmitted content at Step 850. The results of the character recognition process may be checked at Step 855. If the character recognition process fails to produce the desired results (e.g., the system is unable to identify the content, or the content does not include information that is easily searched for), an appropriate notification may be generated at Step 860. The notification may indicate that the attempt to share offline content was unsuccessful and provide a reason for the failure (e.g., no QR code or recognized content available). On the other hand, if either the character recognition is successful or the network succeeded in identifying a QR code, an internal system search may be performed at Step 870 for data corresponding to the recognized content or identified QR code. Such a search may include searching for data saved on a network server or data existing in memory or local storage. At Step 875, the online community may check whether the internal search succeeded in finding data corresponding to the recognized content or identified QR code. If successful, the network may begin a message dissemination process at Step 890, consistent with disclosed embodiments, such as the processes illustrated in the flow diagrams described in FIGS. 2 and 3. If it is determined that the internal search did not locate the desired data, then an external search may be performed at Step 880. Consistent with disclosed embodiments, an external search may include running Internet searches for the desired data. The online community may then check, at Step 885, whether the external search succeeded in finding data corresponding to the recognized content or identified QR code. If successful, the network may begin a message dissemination process at Step 890. Otherwise, the user may be notified at Step 860 that the attempt to share offline content was unsuccessful. The notification may also provide a reason for the failure (e.g., no recognized data available).

Consistent with other disclosed embodiments, computer-readable storage devices may store program instructions that are executable by one or more processors to implement any of the methods, disclosed herein.

The foregoing descriptions have been presented for purposes of illustration and description. They are not exhaustive and do not limit the disclosed embodiments to the precise form described. Modifications and variations are possible in light of the above teachings or may be acquired from practicing the disclosed embodiments. For example, the described implementation includes software, but the disclosed embodiments may be implemented as a combination of hardware and software or in firmware. Examples of hardware include computing or processing systems, including personal computers, servers, laptops, mainframes, microprocessors, and the like. Additionally, although disclosed aspects are described as being stored in a memory on a computer, one skilled in the art will appreciate that these aspects can also be stored on other types of computer-readable storage media, such as secondary storage devices, like hard disks, a CD-ROM, USB media, DVD, or other forms of RAM or ROM.

Computer programs based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), XML, Java, C++, JavaScript, HTML, HTML/AJAX, Flex, Silverlight, or any other now known or later created programming language. One or more of such software sections or modules can be integrated into a computer system or existing browser software.

Other embodiments of the disclosure will be apparent to those skilled in the art from consideration of the specification and practice of the embodiments disclosed herein. In particular, it should be appreciated that the processes defined herein are merely exemplary, and that the steps of the processes need not necessarily be performed in the order presented. It is intended that the specification and examples be considered as exemplary only, with a true scope and spirit of the embodiments being indicated by the following claims.

What is claimed is:

1. A computer-implemented method for delivering a message in an online community, the method comprising:
receiving an indication of one or more intended recipients of one or more messages, wherein the intended recipients are users of an online community capable of configuring user settings associated with receiving messages;
determining, based on at least the indication, user settings associated with the one or more intended recipients;
identifying one or more delivery mechanisms associated with the one or more intended recipients; and
providing, based on at least the one or more identified delivery mechanisms and the determined user settings, one or more messages.

2. The method of claim 1, further comprising:
checking one or more notification rules for a message type, wherein the notification rules are associated with the one or more intended recipients;
triggering an event based on at least the notification rules associated with the one or more intended recipients; and
generating an alert based on at least the triggered event and the notification rules associated with the one or more intended recipients.

3. The method of claim 1, wherein the one or more delivery mechanisms includes at least one of: an e-mail address, a mobile phone number, or a social media account.

4. The method of claim 1, further comprising:
identifying user settings associated with a user-defined time or frequency for message delivery.

5. The method of claim 1, further comprising:
identifying a message type based on at least an analysis of the message format;
providing an analysis of message content; and
identifying user settings associated with user-defined settings for message delivery based on message type or content.

6. The method of claim 1, further comprising:
providing the one or more intended recipients with the option of refusing delivery of one or more messages; and
updating user settings associated with an intended recipient based at least on a response to the option from the intended recipient.

7. The method of claim 1, wherein the one or more intended recipients includes at least one of: a list containing one or more users of the online community, or a group of users of the online community, wherein membership in the group is based on at least each user's user settings.

8. A computer-implemented method of sharing a message, the method comprising:
receiving a message from a sender for at least one intended recipient;
identifying one or more auto-sharing rules of the at least one intended recipient for the one or more message types associated with the message;
associating one or more message types with the received message;
determining whether to share the message, based on at least:
the identified one or more auto-sharing rules, and
whether user settings associated with the sender allow auto-sharing of sender messages; and
based on at least the determination, delivering the message to the at least one intended recipient.

9. The method of claim 8, wherein associating one or more message types with the received message further comprises:
determining whether keywords are assigned to the auto-sharing rule; and
associating the message with one or more keywords if keywords are assigned to the auto-sharing rule.

10. The method of claim 9, wherein associating one or more message types with the received message is based on at least an analysis of message format or content.

11. The method of claim 8, further comprising:
notifying the sender that the message has been shared with users of an online community.

12. The method of claim 11, wherein the users of the online community do not include users other than the at least one intended recipient.

13. The method of claim 8, further comprising:
determining whether to post the message to one or more social media accounts associated with the sender, based on at least the sender's user settings;
posting the message to one or more of the sender's social media accounts based on at least the determination of whether to post the message; and
posting the message to the online community account associated with the sender.

14. The method of claim 13, further comprising:
determining whether to post the message to one or more social media accounts associated with one or more recipients, based on at least the sender's and the one or more recipients' user settings;
posting the message to one or more social media accounts associated with one or more recipients, based on at least the determination of whether to post the message;
determining whether to post the message to one or more online community accounts associated with one or more recipients, based on at least the sender's and the one or more recipients' user settings;
posting the message to one or more online community accounts associated with one or more recipients, based on at least the determination of whether to post the message; and
sending the message to one or more recipients, wherein the one or more recipients are not users of the online community and the sender has not provided social media account information associated with the one or more recipients.

15. A computer-implemented method of posting a message in an online community, the method comprising:
receiving a message from a sender for at least one intended recipient;
associating one or more message types with the received message;
identifying one or more auto-posting rules for the one or more message types associated with the message;
determining whether to post the message to an online community, based on at least:
the identified one or more auto-posting rules, and
whether user settings associated with the sender allow auto-posting of sender messages; and
posting the message to one or more user accounts or groups of the online community based on at least the determination.

16. The method of claim 15, wherein associating one or more message types with the message further comprises:
determining whether keywords are assigned to the auto-posting rule; and
associating the message with one or more keywords if keywords are assigned to the auto-posting rule.

17. The method of claim 16, wherein associating one or more message types with the message is based on at least an analysis of message format or content.

18. The method of claim 15, wherein the one or more user accounts or groups of the online community does not include user accounts or groups associated with the at least one intended recipients.
